(19) United States
(12) Patent Application Publication
(10) Pub. No.: US 2002/0039003 A1
(43) Pub. Date: Apr. 4, 2002

(54) Plasma display panel

(76) Inventor: Hajime Inoue, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/964,535

(22) Filed: Sep. 28, 2001

(30) Foreign Application Priority Data
Oct. 3, 2000 (JP) P2000-303503

(51) Int. Cl. H01J 17/49; H01J 11/02

(52) U.S. Cl. 313/581

(57) ABSTRACT

Disclosed is a plasma display panel capable of improving luminance intensity having a discharge-cell structure which can increase conductance at the time of exhaust and increase the surface area of a phosphor. A plurality of barrier ribs with the plane shape being formed with curve are provided on a back glass substrate to which address electrodes and a dielectric layer are formed and phosphors are formed in the discharge cells between the barrier ribs. The curvature and the pitch of the curved surface of the barrier ribs are determined by the spaces of sustain electrodes and address electrodes. For example, a rectangle or a square under consideration of the spaces or the like of the display electrodes is set to be a structural unit. The curve is drawn as an arc tracing the diagonal of such quadrilaterals and corrugated barrier ribs are formed by arranging these in 180° rotational symmetry to each other along the address electrodes.

### BACKGROUND OF THE INVENTION

1. Field of the Invention

The present invention relates to a plasma display panel which displays images by plasma discharge in discharge space separated by barrier ribs.

2. Description of the Related Art

In recent years, space saving and improvement of portability of displays of personal computers or the like are desired in accordance with a recent trend of light and thin displays. Therefore, various kinds of FPDs (Flat Panel Displays) such as LCDs (Liquid Crystal Displays), FEDs (Field Emission Displays), organic EL (Electroluminescence) displays and PDPs (Plasma Display Panels) have been developed and commercialized in place of cathode ray tubes (CRTs), which had been the mainstream of the displays.

A plasma display panel displays images by emitting light through irradiating ultraviolet light generated by plasma discharge to phosphor and has been expected to create a market for thin/large-screen displays such as wall-hung televisions for home use and large information terminals for public use.

FIG. 1 shows the schematic configuration of a color plasma display panel of the related art. A plasma display panel 100 is AC-type and specifically called a surface-discharge-type. The basic structure including the portion corresponding to 1 unit pixel is shown FIG. 1. FIG. 2 shows part of the cross section of the plasma display panel 100 shown in FIG. 1 taken along the line I-I. The plasma display panel 100 has a structure in which a front glass substrate 111 on the panel side and a back glass substrate 121 are placed opposing to each other. Discharge space 126 is formed between the front glass substrate 111 and the back glass substrate 121 by hermetic sealing in the periphery of the front glass substrate 111 and the back glass substrate 121. A mixed gas or a single gas of neon, xenon and the like is filled into the discharge space 126 as a discharge gas.

A plurality of address electrodes 122 arranged parallel to each other are provided on the back glass substrate 121, and a dielectric layer 123 is provided so as to cover the address electrodes 122. On the dielectric layer 123, a plurality of stripe barrier ribs 124 are provided between each of the address electrodes 122. The discharge space 126 is separated in stripes by the barrier ribs 124 along the extending direction of the address electrodes 122. Between the barrier ribs 124, stripe phosphors 125 in three primary colors, red, green and blue, are periodically provided from the exposed surface of the dielectric layer 123 to the side face of the adjacent barrier ribs 124.

On the other hand, on the front glass substrate 111, a pair of two sustain electrodes (transparent electrodes) 112 (112a and 112b) are provided for surface discharge. A dielectric layer 114 is provided on the sustain electrodes 112a and 112b and a protective layer 115 made of MgO (magnesium oxide) is provided thereon. The sustain electrodes 112a and 112b are provided orthogonal to the extending direction of the address electrodes 122 so as to be in a matrix and are also orthogonal to the extending direction of the barrier ribs 124. Bus electrodes 113 (113a and 113b) are integrally provided on the sustain electrodes 112 (112a and 112b), which are the transparent electrodes.

FIG. 3 is a plan view showing the relation between a pair of display electrodes and 1 unit pixel in the plasma display panel of the related art. In FIG. 3, the address electrodes 122 are located under the phosphors 125 between the barrier ribs 124 extended in straight lines. In the matrix formed by the address electrodes 122 and the sustain electrodes 112, a dot 131 is formed by every intersection point of the address electrodes 122 and a pair of sustain electrodes 112a and 112b. Each of pixels 132 has the phosphors 125 in red, green and blue and formed of three dots 131 lined in parallel under the pair of sustain electrodes 112a and 112b.

When displaying images in color in the plasma display panel 100, wall charge is accumulated on the protective layer 115 in the discharge space 126 through address discharge between the address electrodes 122 and either one of the sustain electrodes 112a or 112b in the discharge space 126 corresponding to the dot 131 desired to be emitting light. Surface discharge (maintenance discharge) is generated across the sustain electrodes 112a and 112b when voltage superimposed on the alternating-current voltage applied across a pair of the sustain electrodes 112a and 112b exceeds a firing voltage with the voltage by the wall charge being bias. A discharge gas emits ultraviolet light by the surface discharge. The phosphors 125 in the dots 131 emit light by irradiation with ultraviolet light to display.

The amount of light emitted from the dots 131 at this time is a main factor for determining the intensity of a PDP and largely depends on the surface area of the phosphors 125. As can be seen from FIG. 1, the surface area of the phosphors 125 comply with the surface area of the barrier ribs 124. Therefore, various kinds of methods for increasing the surface area of the phosphors through improving the configuration of the barrier ribs have been considered in order to increase the amount of light emission.

For example, as shown in FIG. 4, in a method where hexagons are formed in a honeycombed form between the adjacent barrier ribs 124, discharge and emission of light is performed mainly in the discharge space of the hexagons and the surface area is effectively increased. In addition, for example, Japanese Patent Application laid-open 2000-11894 discloses the following method. The barrier ribs are provided for discharge cells of phosphors (blue) which is relatively low in the luminous efficiency and the intensity in the same manner as in the honeycomb structure. The barrier ribs where the surface area is adjusted by widening the narrower portion of the adjacent barrier ribs according to the luminous efficiency of the phosphor while increasing the interior angle of the hexagons in the extending direction of the cells are provided for the other cells. The barrier ribs are formed with the side faces being in left-right asymmetry. Thereby, the light emission area can be increased and the color balance of red (R), green (G) and blue (B) phosphors can be controlled at the same time.

However, the barrier ribs extended in straight lines as shown in FIG. 3 are still common. The reason is that the advantage of the straight barrier ribs such as ease of process and increase of conductance at the time of exhaust by sufficiently exhausting inside the discharge cells exceeds that of the barrier ribs having a complicated configuration as described.

### SUMMARY OF THE INVENTION

The invention has been designed to overcome the forgoing problems. An object of the invention is to provide a plasma display panel capable of improving emission luminance and has a discharge cell structure capable of increasing the conductance at the time of exhaust and the surface area of the phosphor, which is easily processed.

In a plasma display panel of the invention, the plane shapes of the barrier ribs are formed with curved surfaces in a corrugated periodic structure and the like. Preferably, a plurality of the barrier ribs are all in the same configuration and he adjacent barrier ribs are in phase or in opposite phase each other.

In the plasma display panel, the barrier ribs are formed with curved surfaces. Therefore, the surface area of the phosphors is increased while maintaining the conductance at the time of exhaust relatively large.

Other and further objects, features and advantages of the invention will appear more fully from the following description.

### BRIEF DESCRIPTION OF THE DRAWINGS

FIG. 1 is a figure for describing a plasma display panel of the related art.

FIG. 2 is a cross section of the plasma display panel shown in FIG. 1 taken along the line I-I.

FIG. 3 is a figure for describing the relation between the barrier ribs and the display electrodes of the plasma display panel shown in FIG. 1

FIG. 4 is a figure showing the configuration of the barrier ribs in another plasma display panel of the related art.

FIG. 5 is a perspective view showing a schematic configuration of a plasma display panel according to a first embodiment of the invention.

FIG. 6 is a plan view showing the relation of the configuration of the barrier ribs and the position of the display electrodes in the plasma display panel shown in FIG. 5.

FIG. 7 is a plan view for describing a method of defining the configuration of the barrier ribs and the surface area in the plasma display panel shown in FIG. 5.

FIGS. 8A and 8B are plan views for describing the spaces of the barrier ribs in the plasma display panel shown in FIG. 5 and the modification.

FIG. 9 is a plan view showing the relation of the configuration of the barrier ribs and the position of the display electrodes in a plasma display panel according to a second embodiment of the invention.

FIG. 10 is a plan view showing the barrier ribs and the display electrodes for describing an application for the plasma display panel shown in FIG. 9.

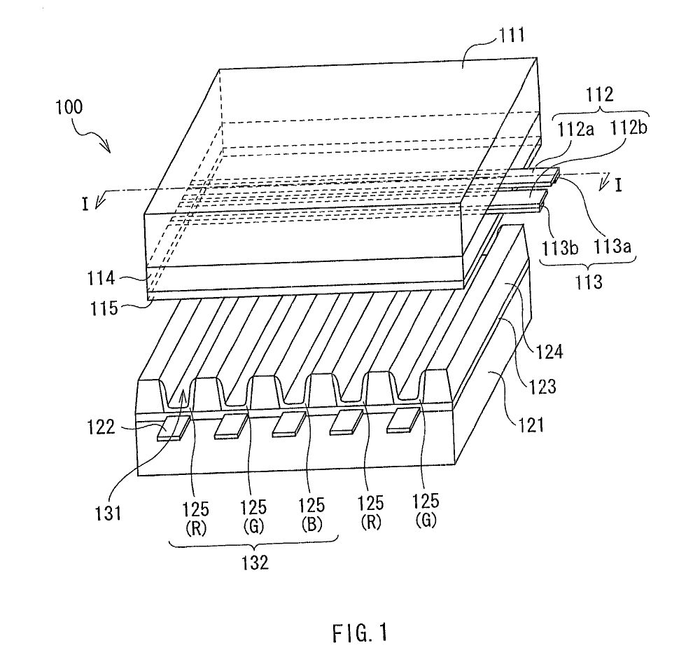

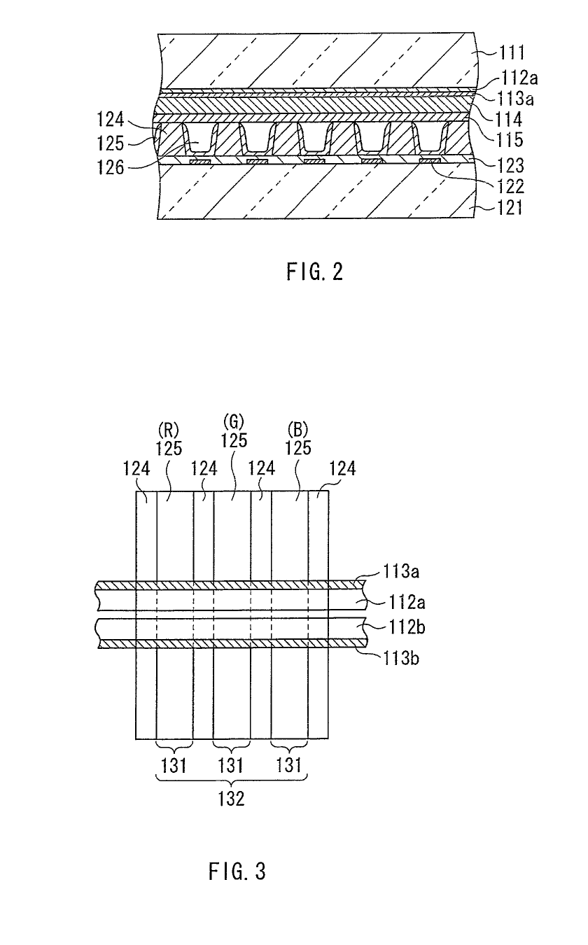

### DETAILEDDESCRIPTION OF THE PREFERRED EMBODIMENTS

In the followings, embodiments of the invention will be described in detail by referring to the drawings.

[First Embodiment]

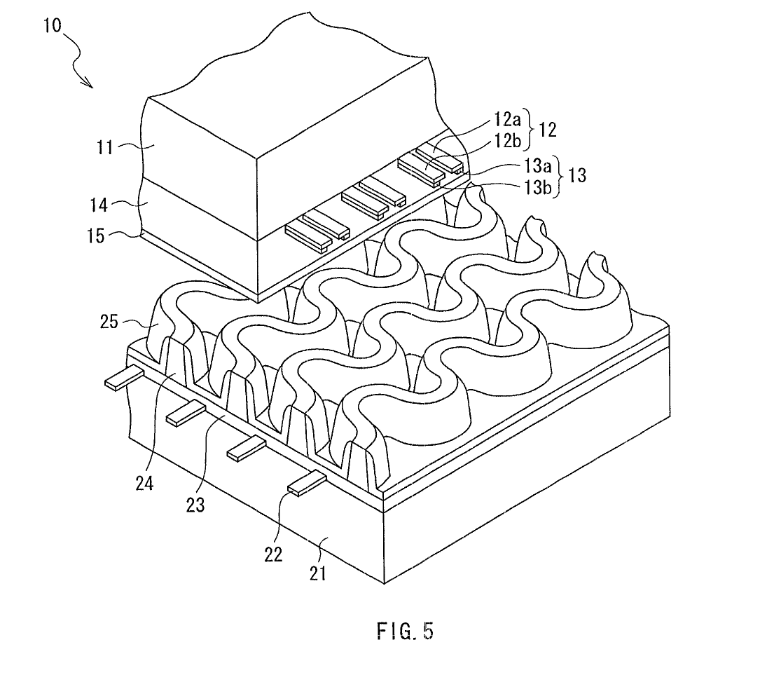

FIG. 5 shows the schematic configuration of a plasma display panel according to a first embodiment of the invention. A plasma display panel 10 has a structure in which a front glass substrate 11 and a back glass substrate 21 are placed opposing to each other. The discharge space is formed between the front glass substrate 11 and the back glass substrate 21 by hermetic sealing in the periphery of the front glass substrate 11 and the back glass substrate 21. A mixed gas or a single gas of neon, xenon or the like is filled into the discharge space as a discharge gas.

The discharge space is divided into discharge cells by a plurality of barrier ribs 24. The barrier ribs 24 according to the embodiment have a periodic structure in which each of the side walls are formed with curved surfaces in a corrugation. The barrier ribs 24 are provided on the back glass substrate 21 and the extending direction is parallel to address electrodes 22.

On the back glass substrate 21 side, a plurality of address electrodes 22 arranged parallel to each other are provided on the back glass substrate 21, and a dielectric layer 23 is provided so as to cover the address electrodes 22, and a plurality of barrier ribs 24 are provided thereon. Between the adjacent barrier ribs 24, phosphors 25 in the three primary colors, red, green and blue are periodically arranged from the exposed surface of the dielectric layer 23 to the side face of the barrier ribs 24.

The structure of the front glass substrate 11 side is the same as the case of the plasma display panel 100 of the related art. In other words, a pair of two sustain electrodes (transparent electrodes) 12 (12a and 12b) for surface discharge are provided directly on the front glass substrate 11, and the bus electrodes 13 (13a and 13b) for decreasing impedance are integrally provided on one of the surfaces of the sustain electrodes 12a and 12b. The dielectric layer 14 and the protective layer 15 are provided in this order on the sustain electrodes 12 and the bus electrodes 13. The dielectric layer 14 accumulates wall charge generated during the address period, serves as resistive element which limits over-discharge current, and has memory maintaining the discharge state. The protective layer 15 has the same functions as those of the dielectric layer 14. In addition, the protective layer 15 is for preventing wear in the sustain electrodes 12 by interrupting the contact between ions/electrons and the sustain electrodes 12.

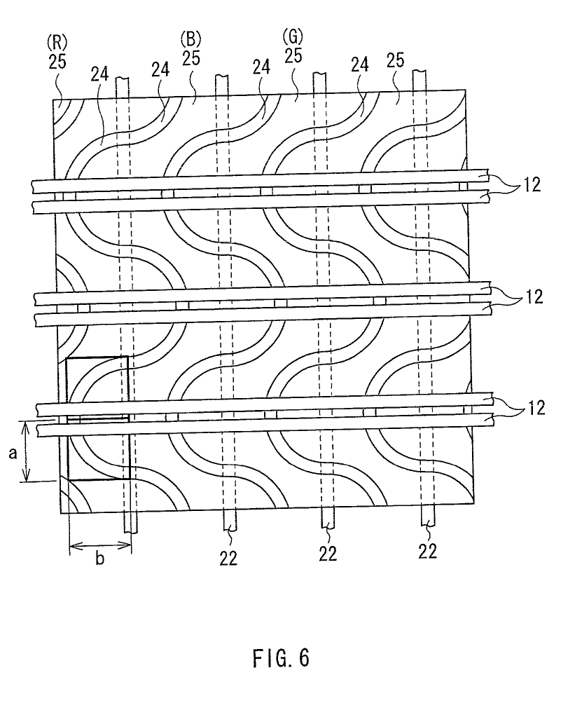

FIG. 6 is a plan view showing the arrangement of the barrier ribs and the display electrodes in the plasma display panel 10. The barrier ribs 24 according to the embodiment have corrugated wall-faces in which semicircles, which are in 180° rotational symmetry to each other, are alternately continued and a plurality of the barrier ribs 24 having the same configuration are arranged in phase. Therefore, the discharge cells are in a shape of side-to-side curvature in which the center of the semicircle is the widest and the width becomes narrower towards the axis of symmetry being away from the center. The shapes of the all discharge cells are the same because the barrier ribs 24 have the equal spaces.

Also, the address electrodes 22 are arranged on the barrier ribs 24 along the central axis in the extending direction. On the other hand, a pair of the sustain electrodes 12 are provided on the center of each semicircle in the corrugated wall-faces of the barrier ribs 24 so as to be orthogonal to the address electrodes 22 forming a matrix. Each intersection point in the matrix corresponds to a dot. As described, in the discharge cells as if they are provided by dots, the light-emitting region contributes to 1 dot becomes larger than the linear cells.

The configuration of the curved surface of the discharge cells (the barrier ribs 24) and the curvature and the pitch which determine the configuration are limited by the spaces between each of the sustain electrodes 12 and the address electrodes 22. Therefore, the region where the curved surface can be provided is naturally determined when defining the curved surface to a given configuration. If the curved surface has a periodic structure, the region where the curved surface can be provided can be indicated by the structural unit. Therefore, the region where the curved surface can be provided is defined as the region of a square or a rectangle in which each of the two adjacent sides is in a predetermined ratio (for example, ½) according to the spaces of two kinds of the electrodes. More specifically, the region is a rectangle in which the two adjacent sides are a and b as shown in FIG. 6, and the barrier ribs 24 are formed with a curve defined as a chord across the opposite angle of the rectangle. The length of the two sides a and b of the rectangle is the value to be called a pitch of the barrier ribs 24 and can be determined appropriately based on the number of pixels, which is a balance between the spaces of the sustain electrodes 12 and those of the address electrodes 22.

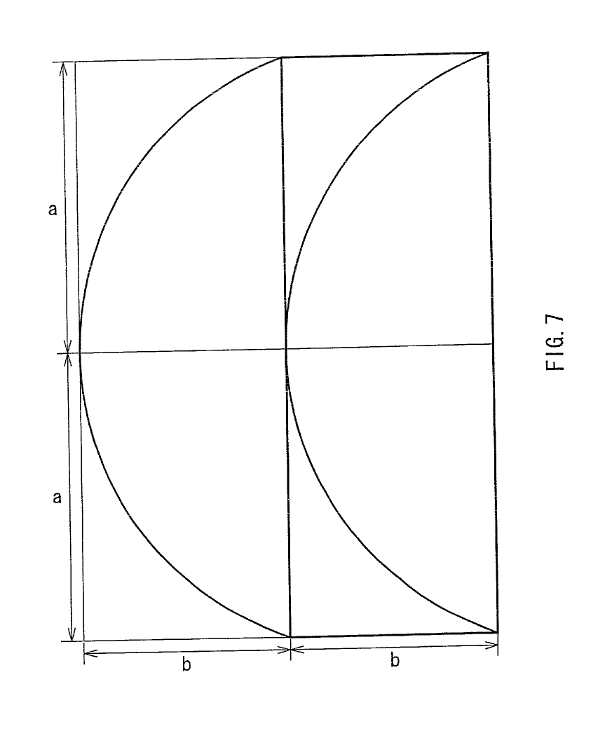

FIG. 7 shows a plan view of the portion of the barrier ribs 24 corresponding to 1 dot in which the curved surface is defined by the region as described. The curve defined by the region where the above-mentioned curved surfaces can be provided is to be the inner wall face of the barrier ribs 24. The curved surface of the discharge cell is an arc of a circle or a curve drawn with the opposing vertexes thereof being the both ends. The same periodic structure is formed as in the case of a semicircle with the arc defined as described being the structural unit. In addition to a circular curve, any kinds of functional curves such as an elliptic curve, trigonometric function, and exponential function are applicable for defining the arc. Other than the curves denoted by the mathematical expression, the curve may be expressed by coordinate (x, y) when the two adjacent sides are to be x-axis and y-axis, for example.

Each of the surface area per dot of the discharge cells formed of the corrugated barrier ribs 24 as described and the linear barrier ribs are estimated from FIG. 7. The spaces of the both barrier ribs are b and the heights are to be the same for comparison. First, the base areas are determined by the width b of the discharge cell and the straight distance 2a between the both ends without depending on the configuration of the barrier ribs, and are 2ab in both cases. The areas of the side faces are determined by the height and the length of the barrier ribs. The heights are the same in this case. Therefore, the size of the areas are in proportion to the length of the barrier ribs and, as can be seen from FIG. 7, the corrugated barrier ribs 24 are longer than the linear barrier ribs and the areas of the corrugated barrier ribs 24 also become larger in accordance with the length. In FIG. 7, when the length b of the side of the barrier ribs 24 is made approximate to 0, the barrier ribs can be considered as a linear configuration. Therefore, it is clear that the surface area of the barrier ribs 24 is necessarily larger than that of the linear barrier ribs. As a result, in a discharge cell using the corrugated barrier ribs 24 as described, the area of the phosphors 25 per structural region in 1 dot can be increased. Incidentally, the surface area of a linear cell is 0.336 (mm²) and that of a corrugated cell is 0.349 (mm²) provided a=b=240 μm, height=130 μm and thickness=60 μm in the inner wall.

<Modification>

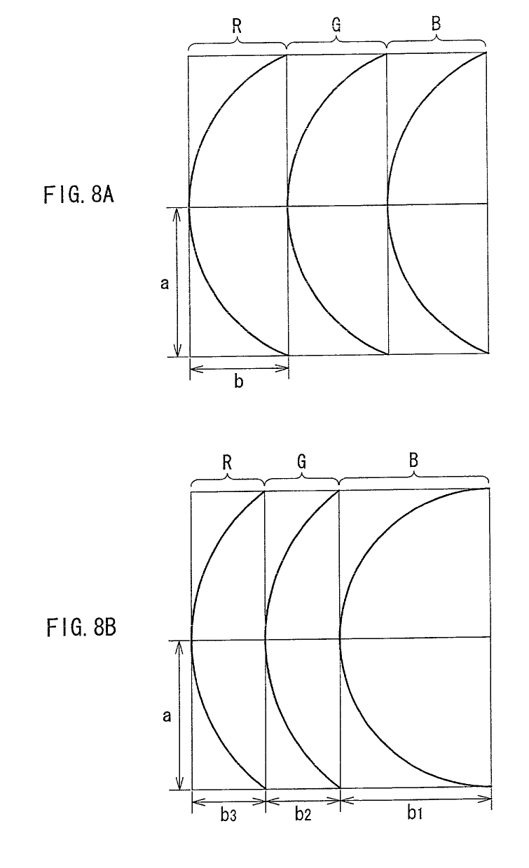

There is naturally a preferable value in the ratio of the length of the two sides a and b of the region where the curved surface can be provided since the length is determined based on the spaces of two kinds of the electrodes as described. FIGS. 8A and 8B show an example of a cell pattern in such ratio. FIG. 8A shows the barrier ribs 24 having equal spaces and FIG. 8B shows the barrier ribs 24 having spaces which vary according to the kinds of the phosphors 25. In FIG. 8A, discharge cells formed with the phosphors 25 with each luminance color, red (R), green (G) and blue (B) are provided periodically in equal spaces. The ratio a:b of the length a to b is 1:1.5 in this case.

On the contrary, in FIG. 8B, the width of every discharge cell varies and the cell with a blue (B) phosphor 25 has wider width than the cells with green (G) and red (R) phosphors 25 (b₁>b₂, b₃; b₂=b₃). The reason is that the intensity of blue is lower compared to those of green and red so that the light-emitting area is relatively increased. The ratio of the length a to b in the blue cell is 1:1 and that of the green and red cells is 1:2. As described, the spaces of the barrier ribs 24 are constant in the first embodiment. However, for example, it is possible to set the spaces by each cell according to the kinds of the phosphor 25. In this case, it is appropriate that the ratio of the length a to b lies within the range of 1:1 to 1:2 as the value for actual fabrication.

Description of the first embodiment will be further continued. The method of manufacturing the plasma display panel 10, operation and effects described hereinafter are also the same in the modification.

The plasma display panel 10 as described can be fabricated, for example, as follows. First, the sustain electrodes 12 made of a transparent electrode material such as ITO (alloy oxide of indium and tin) or SnO₂ are formed by sputtering on the front glass substrate 11 made of glass with a high distortion point. Other examples used for the front glass substrate 11 are soda glass (Na₂O.CaO.SiO₂), borosilicate glass (Na₂O.B₂O₃.SiO₂), forsterite (2MgO.SiO₂), lead glass (Na₂O.PbO.SiO₂) and the like. Then, the bus electrodes 13 made of chrome (Cr), copper (Cu), or a stacked film of these are formed on the sustain electrodes 12 by sputtering or photolithography. Next, the dielectric layer 14 made of, for example, glass with a low melting point is formed by printing and the protective film 15 made of magnesium oxide (MgO) is formed by electron beam evaporation or vacuum evaporation.

Then, the address electrodes 22 made of, for example silver (Ag) or aluminum (Al) are formed by pattern printing on the back substrate 21 made of the same material as that of the front glass substrate 11. The dielectric layer 23 made of silicon dioxide (SiO₂) is formed thereon by vacuum evaporation.

The corrugated barrier ribs 24 are formed on the dielectric layer 23. The various kinds of insulating materials, for example, a mixture of glass with low melting point and metallic oxide such as alumina can be used for the barrier ribs 24. An example of the forming method is sand blasting where paste containing a barrier ribs material in a predetermined thickness is uniformly applied and dried, masks are provided in a predetermined configuration of barrier ribs by photolithography, portion other than the masks is removed by biasing abrasive, and the remained portion is calcined. At this time, the barrier ribs 24 are to be formed by the mask in corrugated configuration as shown in FIG. 6. Curved surfaces with high precision can be formed by sand blasting. Then, the phosphors 25 are formed by screen-printing or photolithography between each of the barrier ribs 24 and the side-wall faces of the barrier ribs 24. It is possible to use an appropriate material with high quantum efficiency (luminous efficiency) for the phosphors 25 selected from various kinds of phosphor materials.

Then, a seal layer made of glass with a low melting point is formed in the periphery of the back glass substrate 21 by screen-printing. The back glass substrate 21 and the front glass substrate 11 are bonded and the seal layer is calcined, thereby sealing the substrates. At last, the discharge space between the back glass substrate 21 and the front glass substrate 11 are exhausted and Ne or a mixed gas of He and Xe is filled as a discharge gas. At this time, there are narrower portion and wider portion in the spaces of the barrier ribs 24 due to their curved form. However, the narrower region is relatively small and is continued to the wider region by the curved surfaces. Therefore, exhaust of the discharge space is relatively easy and the conductance is not largely deteriorated.

For example, the plasma display panel 10 as described acts as follows. First, pulse voltage higher than the firing voltage_{bd} is applied between either one of the pairs of all the sustain electrodes 12 and the address electrodes 22 for a short period of time. When glow discharge is generated thereby, wall charge by dielectric polarization is accumulated on the surface of the protective film 15 closer to the sustain electrodes 12 on the side where voltage is applied, and the apparent firing voltage is decreased (address discharge). Next, in the discharge cells corresponding to dots, which are not shown, alternating voltage is further applied across the sustain electrodes 12 and the address electrodes 22, which address discharge has been performed earlier for glow discharge, thereby eliminating the accumulated wall charge (erasing discharge). When a predetermined alternating pulse voltage is applied to the pairs of all the sustain electrodes 12, the voltage across the two sustain electrodes 12a and 12b exceeds the firing voltage by superimposing the voltage by the wall charge and the pulse voltage, and surface discharge is generated (maintenance discharge) in the discharge cells to which the wall charge is accumulated.

When surface discharge is generated, the discharge gas inside the discharge space irradiates ultraviolet light by plasma discharge. The ultraviolet light is irradiated by the phosphors 25. The phosphors 25 excite and emit light in a color peculiar to the material. Thereby, dots are displayed. At this time, the intensity become higher compared to that of the linear discharge cells since the surface area of the phosphors 25 contribute to emission of light is larger.

In a plasma display panel according to the embodiments, the barrier ribs 24 have a corrugated curve in phase as shown in FIG. 6. Therefore, the surface area becomes larger compared to the linear barrier ribs of the related art. As a result, the area of the phosphors 25 can be made larger. Thereby, the luminance intensity can be improved.

Also, in a plasma display panel according to the embodiment, the barrier ribs 24 are in a corrugated configuration in phase. Therefore, the barrier ribs can be easily processed and the conductance at the time of exhaust can be increased.

[Second Embodiment]

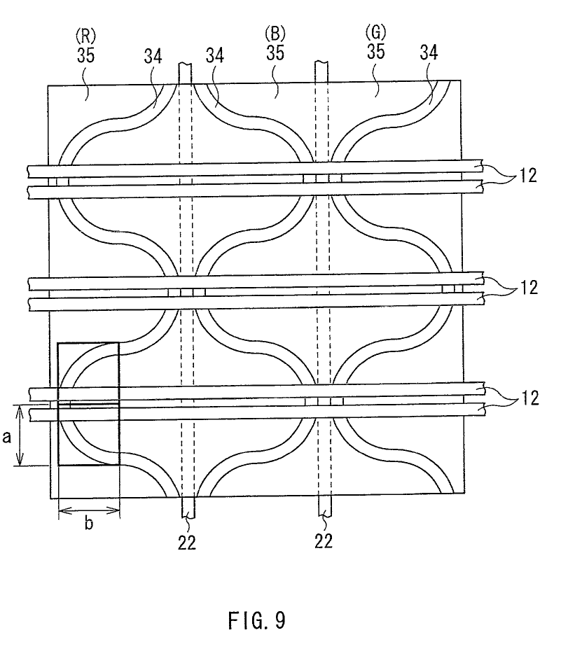

FIG. 9 is a plan view showing the arrangement of the barrier ribs and the display electrodes of a plasma display panel according to a second embodiment. The plasma display panel is formed in the same manner as in the plasma display panel 10 according to the first embodiment except for barrier ribs 34 and phosphors 35 shown in FIG. 9. Therefore, the same reference characters are applied to the same structural elements and the description will be omitted.

The barrier ribs 34 have corrugated wall-faces in which semicircles, which are in 180° rotational symmetry to each other, are alternately continued and the adjacent barrier ribs 34 in the same configuration are arranged in opposite phase. The discharge cells in this case are in a shape where the center of the semicircle is the widest and the width becomes narrower towards the axis of symmetry being away from the center while the narrow portion of the cell in the middle corresponds to the wide portion of the cells on both sides. The spaces of the barrier ribs 34 are also constant in this case and the configurations of all the discharge cells are the same. Also, phosphors 35 in three primary colors, red, green, and blue are periodically arranged between the adjacent barrier ribs 34. The address electrodes 22 are arranged along the center of symmetry between the adjacent barrier ribs 34. On the other hand, a pair of the sustain electrodes 12 are provided on the center of each semicircle in the corrugated wall-face of the barrier ribs 34 so as to be orthogonal to the address electrodes 22 forming a matrix.

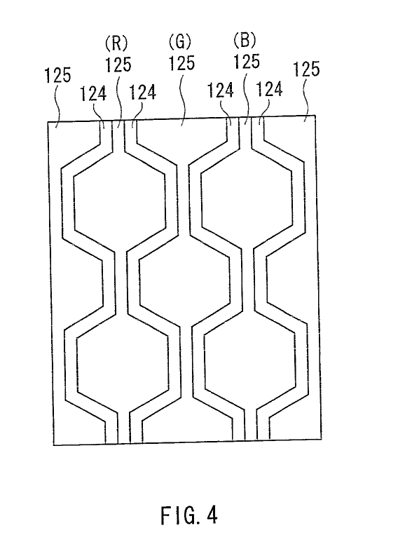

As described, the spaces of the discharge cells as if they are closed by each dot have the light-emitting region which contributes to 1 dot larger than not only the linear cells but also the polygonal cells (for example, shown in FIG. 4). The reason is that although the polygon determining the configuration of the cells is set so as to inscribe the curve such as a circle or an ellipse, or can obtain a curve tracing locus contacting the angle of the polygon, the periphery of the polygon is shorter than that of the curve. Incidentally, the surface area of the corrugated cells in opposite phase according to the embodiment becomes 1.12 times the surface area of the honeycomb cells provided that a=b=240 μm and height=130 μm in the inner wall.

In this case, the region where the barrier ribs 34 can be provided, that is, a rectangle with adjacent sides a and b, is defined as shown in FIG. 9. The periodic structure of the barrier ribs 34 are set in the same manner as in the barrier ribs 24 according to the first embodiment and the modification.

There are narrower portion and wider portion in the spaces of the barrier ribs 34. However, the narrower region is relatively small and is continued to the wider region by the curved surfaces. Therefore, exhaust of the discharge space is relatively easy so that the conductance is not largely deteriorated.

<Application>

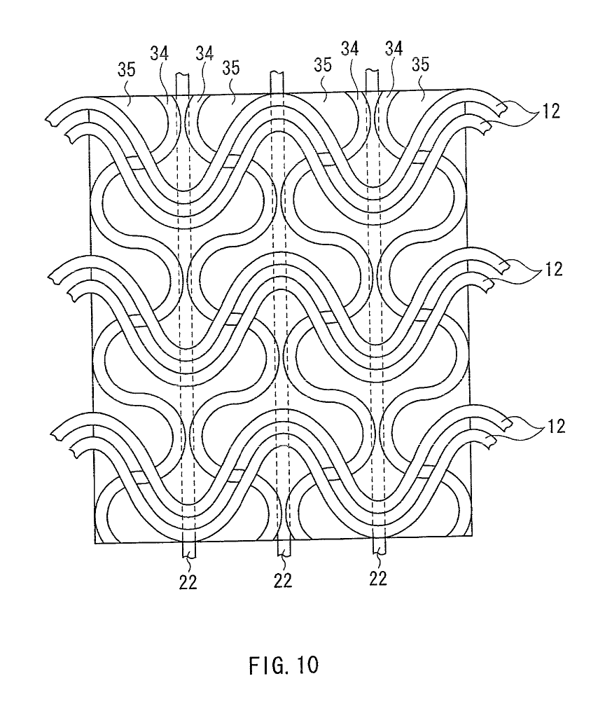

In the above-mentioned second embodiment, the display electrodes are to be in a matrix formed with straight lines. However, as shown in FIG. 10, the sustain electrodes 12 and bus electrodes 13 may be in a curved form. The configuration of the sustain electrodes 12 can be set in the same manner as in the barrier ribs 34. In other words, it is set to have the pitch so that the centers of semicircles coincide on the address electrodes 22 while having the curvature in which the centers of the semicircles are located in the wider portion of the discharge cells. Thereby, matrices are formed in the wider regions which actually contribute to light emission in the discharge space and the area of the sustain electrodes 12 contributing to discharge can be increased.

As described, in a plasma display panel according to the embodiment, the barrier ribs 34 are to be in corrugated curve in opposite phase as shown in FIG. 9. Therefore, the surface area become larger compared to a polygonal barrier ribs such as honeycomb barrier ribs. As a result, the area of the phosphors 35 can be increased. Thereby, the luminance intensity is improved.

Also, in the embodiment, the barrier ribs 34 are formed not with plane but curved surface. Therefore, the conductance at the time of exhaust can be increased compared to that of the polygonal barrier ribs.

The invention has been described by referring to the embodiments. However, the invention is not limited to the above-mentioned embodiments but various kinds of modifications are possible. For example, in the above-mentioned embodiments, an AC-driven PDP for color display is described. However, the invention is not limited to this but can be widely applied to PDPs which improve the intensity.

As described, in a plasma display panel according to the invention, the barrier ribs are formed with curved surfaces. Therefore, the effective surface area of the discharge cells is increased, thereby increasing the area of the phosphors which contribute to light emission. As a result, the luminance intensity is improved and the conductance at the time of exhaust can be increased at the same time.

Obviously many modifications and variations of the present invention are possible in the light of above teachings. It is therefore to be understood that within the scope of the appended claims the invention may be practiced other wise than as specifically described.

What is claimed is:

1. A plasma display panel having a plurality of discharge spaces separated by a plurality of barrier ribs, wherein:
plane shapes of the barrier ribs are formed with curved surfaces.

2. A plasma display panel as claimed in claim 1, wherein the plane shapes of the barrier ribs have corrugated periodic structure.

3. A plasma display panel as claimed in claim 2, wherein the periodic structure of the barrier ribs is formed by symmetrically combining a structural unit which is a circle or an arc of a curve obtained by both ends being two opposing vertexes of a square or a rectangle with a predetermined dimension.

4. A plasma display panel as claimed in claim 2, wherein the plurality of the barrier ribs are all in the same configuration and the adjacent barrier ribs are in phase each other.

5. A plasma display panel as claimed in claim 2, wherein the plurality of the barrier ribs are all in the same configuration and the adjacent barrier ribs are in opposite phase each other.

6. A plasma display panel as claimed in claim 2 further comprising a sustain electrode and a bus electrode provided on the discharge spaces, wherein:
plane shapes of the sustain electrode and the bus electrode also have corrugated periodic structures.
